(19) United States
(12) Patent Application Publication
(10) Pub. No.: US 2019/0005570 A1
(43) Pub. Date: Jan. 3, 2019

(54) VOICE INTERFACE SHOPPING SYSTEM

(71) Applicant: MARS Advertising, Inc. d/b/a The Mars Agency Group, Southfield, MI (US)

(72) Inventors: Ethan Goodman, Southfield, MI (US); Christian Spinillo, Southfield, MI (US)

(21) Appl. No.: 16/022,215

(22) Filed: Jun. 28, 2018

Related U.S. Application Data
(60) Provisional application No. 62/525,957, filed on Jun. 28, 2017.

(51) Int. Cl. G06Q 30/06; G06F 3/16; G06F 17/30; G10L 15/26

(52) U.S. Cl. CPC G06Q 30/0639; G06Q 30/0641; G10L 15/26; G06Q 30/0625; G06F 17/3097; G06F 3/167

(57) ABSTRACT

The present invention relates to a voice interface shopping system that can assist customers in making purchasing decisions in a retail environment that extracts search variables from interactions with customers and combines these search variables with specific business rules stored in an admin server to locate products that fit the customer's inputs or requests and then uses a connected lighting system to highlight the product or products to the customer.

### CROSS REFERENCE TO RELATED APPLICATION

This application claims priority to provisional U.S. Application No. 62/525,957 filed on Jun. 28, 2017, which is hereby incorporated herein by reference in its entirety.

### BACKGROUND OF THE INVENTION

### 1. Field of the Invention

The present disclosure relates generally to a voice interface shopping system that can assist customers in making purchasing decisions in a retail environment. Specifically, the disclosure is for a voice interface shopping system that extracts search variables from interactions with customers and combines these search variables with specific business rules stored in an administrative (“admin”) server to locate products that fit the customer's inputs or requests and then reads out the located product's name and description while using a connected lighting system to highlight the product(s) to the customer.

### 2. Description of Related Art

Customers often need assistance in determining which specific product they would like to purchase, as well as learning about comparable products or product information. For example, when purchasing a new television, a customer may need help determining which televisions at a store match his or her desired specification, i.e. size, resolution, price, etc. Currently, most retail establishments depend on sales employees to help customers make these decisions. Maintaining trained and knowledgeable employees costs time and money for the retail establishment. Additionally, an employee may not be knowledgeable about every aspect of a given item, and a customer may have questions about the item that an employee cannot answer. Further, interactions between employees and customers are generally not recorded. Therefore, these interactions cannot provide quantifiable metrics about details which drive the customer's purchasing decisions. Lastly, some customers feel an inherent sales pressure in situations where an employee is helping them or may be embarrassed to ask questions and appear uneducated.

Many retail establishments have begun to incorporate interactive sales kiosks in their stores which allow customers to look up the location and price of an item. These kiosks typically include a screen and a keyboard, or a touch screen in which a customer may look up information about a product. However, none of these kiosks allow for a voice interactive experience which helps a customer decide what to purchase by narrowing down a variety of products based on the customer's verbal input criteria, nor do they highlight the suggested products at the shelf via a connected lighting system. Some retailers have also launched their own applications for use on customer's mobile devices, but these applications have similar limitations as the kiosks and do not provide the customer the ability to interact naturally, while learning about different products at the shelf.

It is therefore desirable to have a voice interactive shopping system that is easier to use, removes the barriers that exist with sales employees, and that can naturally interact with a customer to help that customer select a product.

### SUMMARY OF THE INVENTION

The present invention provides for a voice interactive shopping system for use in retail stores to assist customers in receiving product information and to aid in product selection. In practice, the customer has a virtual conversation with the system. The system begins by prompting the customer by asking simple questions and the customer provides answers specifying, for example, a characteristic of what they are looking for. The shopping system then answers the customer by providing output indicating which product or products fit those criteria, or prompts the customer by asking additional questions. The voice interactive shopping system comprises a voice input/output device (“VIOD”) with voice interface capabilities encompassing a speaker and a microphone, a cloud software component system including a voice application, an artificial intelligence engine and an admin server, a connected lighting system, and a microcontroller that can receive instructions from the cloud software system and control the connected lighting system. The VIOD could be a custom fabrication or an off-the-shelf solution such as a smart speaker or a touchscreen tablet with voice processing capability. The VIOD may be mounted on or placed adjacent to, for example, a shelf in a store aisle, an end cap of a store aisle, or a free standing merchandising display. The VIOD can include multiple input types and ports to support a variety of output options, including but not limited to, visual and audio content and any variety of lighting configurations. The unit may also include a touch screen display to allow the system to return information visually rather than, or as well as, verbally. Additionally, the system can receive and send information via SMS or other digital messaging services.

The system makes product selection easy and intuitive for shoppers. The customer can interact with the system in a similar manner to interacting with a retail employee. Further, some customers may feel pressure to make a purchase when talking to an employee. Accordingly, the automated system provides shoppers with low-pressure access to product information and selection assistance in store. The system also makes customer support more scalable for retailers as installing additional hardware units of the shopping system may be easier and cheaper than hiring additional employees. In some examples, the system can integrate with a retailer's existing communication systems (e.g. intercoms, 2 way radios, cell phones, SMS, etc.) to alert an employee for assistance, and provide that employee with helpful context and information before engaging in a personal interaction with the customer.

The system further provides a central software solution for managing voice-driven interactions. The central software solution has two components: 1) a voice application component, which is consumer facing and consists of the voice interaction (including dialogue) and decision/logic tree capabilities; and 2) an admin server, which contains vendor specific product data (price, description, inventory level, shelf location, lighting parameters, etc.). The content contained in this admin server likely differs from retailer to retailer. The software solution can be custom programmed to meet a particular retailer's needs or goals, but generally, there are a few main templates with standard question types, decision trees and data fields, upon which the voice interaction is built. One template is product selection, which helps a customer choose a product by progressing through a list of questions designed to elicit narrowing responses. For example, this template could help find new products that are similar to the customer's current favorite products, or serve recommendations for a gift based on the approximate price the customer wishes to spend. Another template is product education, which can provide the customer with detailed information about individual products or brands of products available for sale, such as price, ingredients/components, special promotions, warranties, etc.

The system can also include artificial intelligence (AI) components that can further enhance the system's ability to provide assistance to customers. In these embodiments, the system receives input requests from customers as described above, but then also learns from past customer interactions and purchasing decisions for the purposes of streamlining the voice interaction, better anticipating customer answers and inputs, and making better recommendations in future interactions. For example, the AI may learn that customers prefer certain products more than others on rainy days, or that men typically prefer one product whereas women prefer another, etc. The AI of the system learns and improves from each customer interaction through a process known as machine learning, which allows the system to provide greater levels of specific assistance to specific customers. Further, the natural language processing (“NLP”) skills of the system increase as time passes due to the AI capabilities, which further improves the voice interface capabilities and overall customer experience.

In some further embodiments, the system can make in-store interactions more measurable for brands and retailers. For example, the system will record information about interactions with customers so as to provide valuable insight into which customer paths, question types, product attributes, etc., are most likely to influence customer purchasing decisions. The system has the ability to gather data from a number of different sources and can provide this information to the retailer via a real-time analytics dashboard connected to the admin server. Further, the system has the ability to connect through an application program interface (“API”) to the retailer's point of sale (“POS”) system to allow additional data gathering and sales attribution. It can also connect to other data sources such as cameras and/or traffic counters at the shelf or elsewhere in the retailer's store.

The novel features and construction of the present invention, as well as additional objects thereof, will be understood more fully from the following description when read in connection with the accompanying drawings.

### BRIEF DESCRIPTION OF THE DRAWINGS

The improved process of the invention is further described and explained in relation to the following figures of the drawings wherein:

FIG. 1 is a view of an example of the voice interface shopping system of the present invention.

FIG. 2 is a block diagram of the voice interface shopping system of the present invention.

FIG. 3 is block diagram of the software system of the voice interface shopping system of the present invention.

FIG. 4 is a flow diagram of the voice interface shopping system of the present invention.

FIG. 5 is a perspective view of a shelf insert with embedded light strips for use with the present invention.

Like reference numerals are used to describe like parts in all figures of the drawings.

### DESCRIPTION OF THE PREFERRED EMBODIMENTS

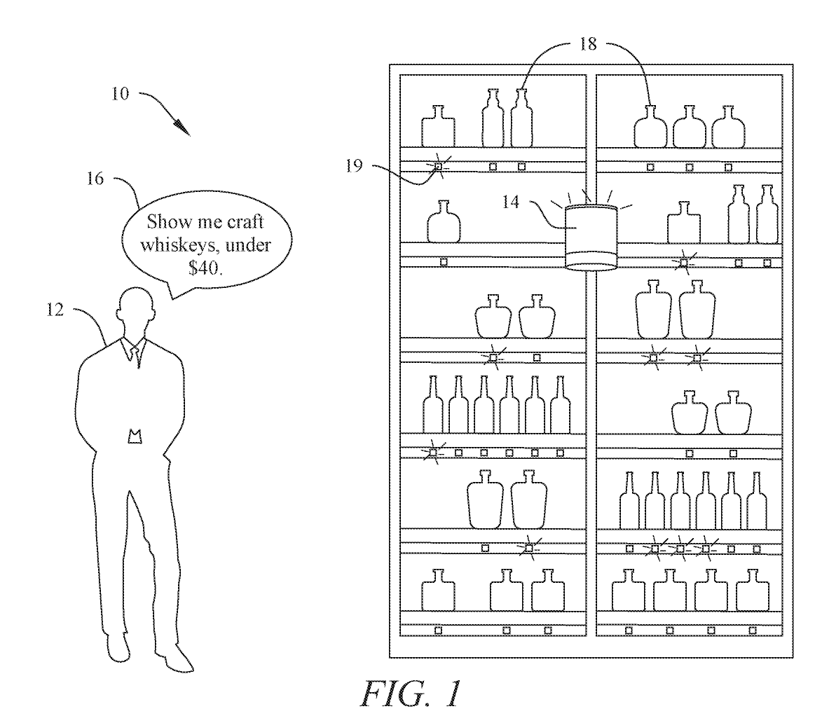

Referring to FIG. 1, an embodiment of voice interactive shopping system 10 is shown. Customers use voice interactive shopping system 10 in retail stores to assist in receiving product information and to aid in product selection. Customer 12 provides voice input 16 to shopping system 10 specifying for example, a characteristic of what they are looking for, and shopping system 10 provides output indicating which product or products 18 fit those criteria.

Voice interactive shopping system 10 employs voice input/output device (“VIOD”) 14 with voice interface capabilities, connected lighting system 19, and a software component system (not shown) including a voice application, an artificial intelligence engine and an admin server. VIOD 14 comprises voice interface capabilities, including a speaker and a microphone, and is preferably a smart speaker or a touchscreen tablet with a voice interface. VIOD 14 may be mounted on or placed adjacent to, for example, a shelf in a store aisle as shown in FIG. 1, an end cap of a store aisle, or a free standing merchandising display. VIOD 14 can include multiple input types and ports to support a variety of output options, including but not limited to, visual and audio content and any variety of lighting configurations. VIOD 14 may further include a touch screen to allow system 10 to return information via the display rather than by voice commands 16.

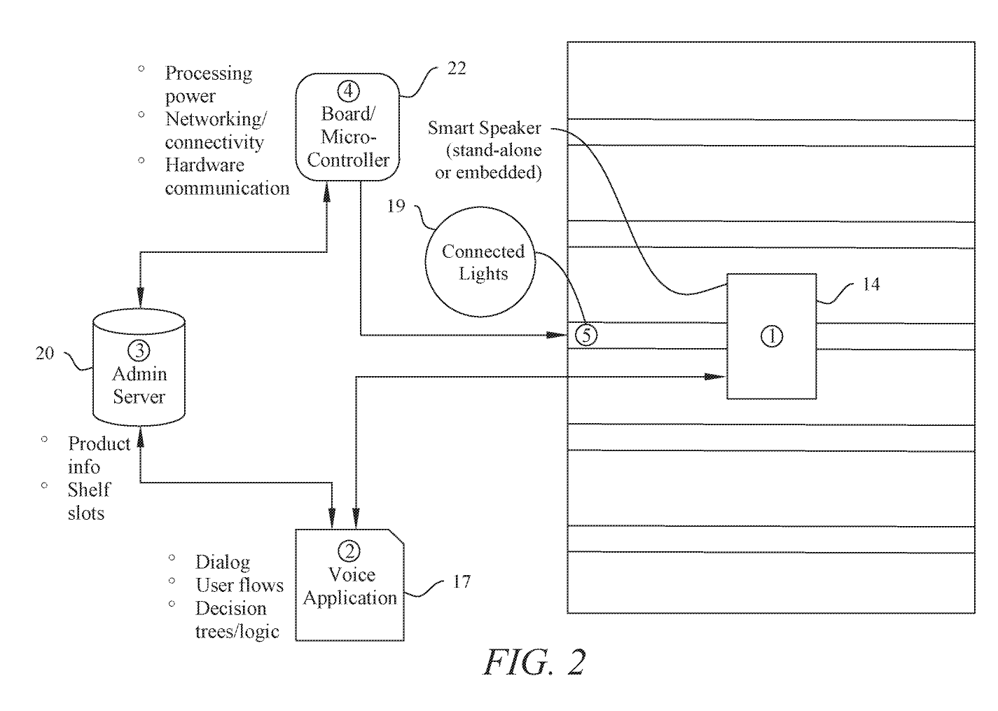

Referring to FIG. 2, VIOD 14 is connected to software program 17 using an artificially intelligent voice service and related API. The artificially intelligent voice service creates a dialog with the customer by receiving and interpreting the voice input from the customer and responding with questions, answers, or prompts based on the received voice commands. The artificially intelligent voice service also is capable of extracting search variables from the customer's voice interaction, which is used to drive product searching. Software program 17 also houses decision trees and logic to direct the dialog and retrieve specific product information from admin server 20.

Software program 17 communicates the extracted search variables to admin server 20, which returns selected product information based on a product search performed by software program 17. The product search that is performed is determined by the artificially intelligent voice service after receiving the voice input from the customer. In the preferred embodiment, admin server 20 is specific to a retail establishment. Admin server 20 houses product names, descriptions and other filtering attributes as well as provides the retail establishment's inventory, stocking details and shelf location of any identified products along with other data values. Admin server 20 allows a retailer to specify and control how shopping system 10 interacts with customers, and what products and information are returned in response to the interaction with the customer.

Further, admin server 20 allows a retailer to create and control the rules and logic for using the data in the system and to manipulate how shopping system 10 responds to the customers. This data manipulation could include, but is not limited to, the steps of adding products, specifying how the API will return those products, setting campaign properties, and indicating which store(s) will be participating in the campaign. Campaign properties are, in some examples, the duration of the campaign and whether products contained in the campaign are available for online ordering. Adding a product could include, but is not limited to, adding an associated dialogue to be outputted by shopping system 10 when the specific product is returned in a customer's search, setting the location of the product on the shelf, end cap or merchandising display, adding an image of the product, and adding searchable metrics to the product. Searchable metrics of products are the pieces of information that are compared by admin server 20 in response to the extracted search variables received from software program 17. Admin server 20 further allows retailers to access a real-time analytics dashboard, which contains valuable data recorded by the system about customers' at-shelf interactions.

Admin server 20 of shopping system 10 preferably is implemented using a cloud based server architecture, but in alternative examples, admin server 20 can reside on a local server, a remote server, or any similar configuration. VIOD unit 14 can interface via software program 17 with admin server 20 via web service calls, direct connection, or any similar method.

Once software program 17 has received product information from admin server 20, software program 17 sends instructions to microcontroller 22, which is the hardware responsible for receiving and processing power for the lighting system, connecting the system to the network and communicating with additional hardware. Microcontroller 22 has one input for power and one input for light connections, though it may have other connections as well. Microcontroller 22 operates lighting system 19 to highlight the product(s) 18 that meet the customer's selection parameters. In the preferred embodiment, lighting system 19 is embedded or retrofitted on the shelves that house the products, and lights up proximate to a given item when the item is indicated by the software program as fitting the customer's needs. For example, if a customer inquires about craft whiskeys, lights of lighting system 19 will illuminate to indicate those that fit that criteria. In alternative examples, shopping system 10 may include a touchscreen, and the touchscreen may display images to indicate the products whether independently or in combination with lighting system 19.

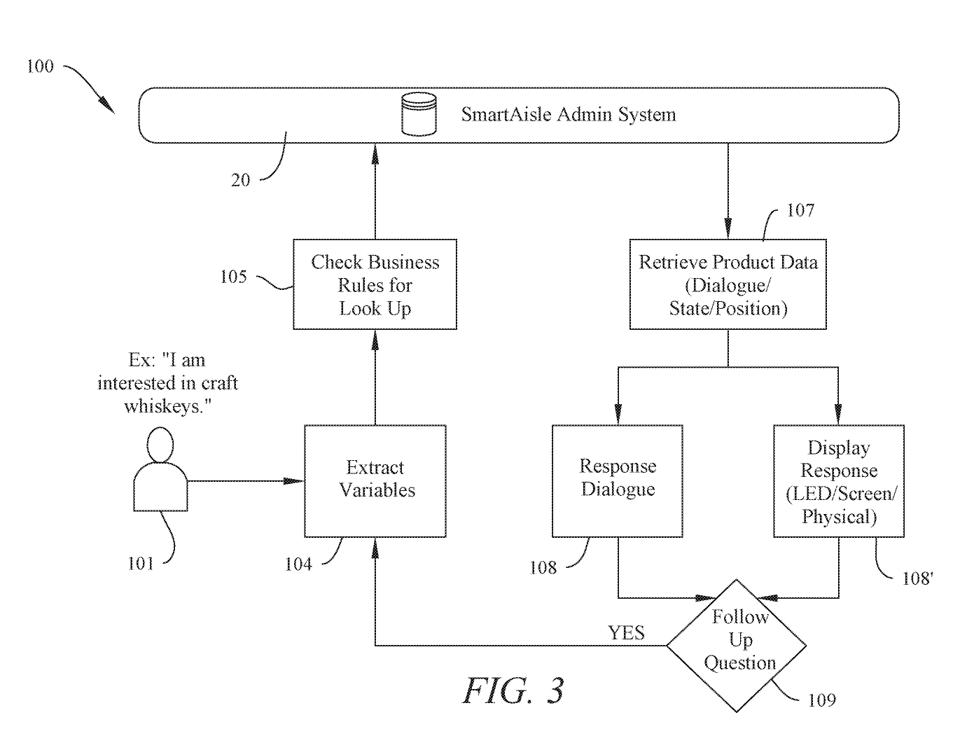

Referring to FIG. 3, method 100 of providing product information to a customer using voice interactive shopping system 10 is shown. Initially, a customer inputs a request to voice-interactive shopping system 10 at step 101. In this example, the customer uses the voice input of the system by saying “I am interested in craft whiskeys.” Alternatively, the customer can input his or her requests using the customer's mobile phone via a text application for example. After receiving the input, shopping system 10 extracts variables at step 104 from the customer's input—such variables including “craft” and “whiskeys” from the example above.

At step 105, shopping system 10 uses the extracted variables to generate limiting categories or search filters based on a retailer's specific rules. These rules are set by the individual retailer and are communicated to shopping system 10 from admin server 20. An example business rule may specify “look for in-stock, if not in-stock offer to order online and deliver to store or home.” Shopping system 10 communicates the extracted variables and the determined search filters from the specific business rules through the API to admin server 20. Shopping system 10 then receives information regarding products matching the specific search, including the extracted variables and search filters, at step 107. Shopping system 10 subsequently outputs an auditory dialogue at step 108 and/or a visual display on a screen at step 108′ to the customer about the matching products returned by the search. Additionally, a lighting system visually indicates the matching products at step 108′ either via lighting, use of a display screen and/or another way of indicating the returned product or products.

At step 109, shopping system 10 may further provide a follow up question to the customer. If there are still multiple search-returned products matching the customer's criteria, shopping system 10 may prompt the customer for more information by asking these follow-up questions to further narrow down the choices. In this situation, shopping system 10 receives the customer's new input and returns to step 104 to extract the new follow-up variables, which will be used to further narrow the search. In some examples once the customer has decided on a specific product, the customer can instruct the system to ensure that the product is delivered to their home or to the front of the store for checkout. The system may be connected to the store inventory management software, stockroom communications tools, and POS terminals, for example.

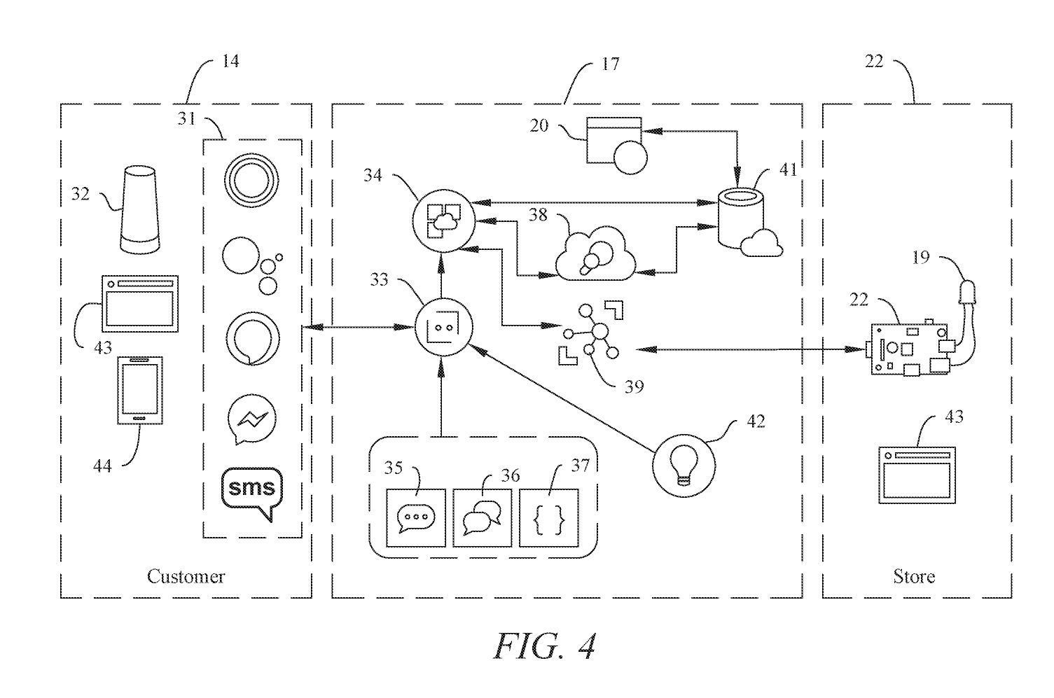

Referring to FIG. 4, a more detailed diagram of interactive shopping system 10 is shown, and specifically, a more detailed diagram of software program 17 is shown. VIOD 14 is shown in various embodiments in the dashed line box indicated by numeral 14. A customer can interact with software system 17 through smart speaker 32, which allows voice interaction with software system 17. Smart speaker 32 preferably allows the customer to voice interact through known voice interaction systems. Sub-box 31 shows various embodiments of how a customer could interact with shopper system 10 via mobile device 44 or touch screen 43, rather than with smart speaker 32.

The inner workings of software program 17 are shown in dashed line box 17. Conversational bot service 33 is a software application that converses with the customer in natural language. Conversational bot service 33 receives the voice interaction, and/or non-voice interaction if initiated via a mobile device, from the customer and formulates replies in natural language (either written or spoken) back to the customer. Conversational bot service 33 further comprises speech API 35, question and answer generator 36 and natural language processing (“NLP”) engine 37. Speech API 35 is used to convert the customer's spoken language into text for use by the applications in software program 17. Question and answer generator 36 trains the AI software program 17 to respond to a customer's questions. NLP engine 37 takes customer's questions and extracts the key variables software program 17 will use to search for to ultimately recommend products that fit the customer's needs. Application insights 43 captures runtime metrics to understand the performance and usage of conversational bot service 33.

Conversational bot service 33 uses API 34 to communicate with search engine 38, which is designed for fast data retrieval. Search engine 38 uses the extracted text to query relational database management system 41, which stores product data. Admin server 20 is also part of software system 17 and is responsible for storing product management information, inventory data and product location information, such as where on a particular shelf a product is located. Internet of Things (“IoT”) hub 39 can be used to communicate with certain IoT devices in order to control affiliated devices wirelessly. For example, in the preferred embodiment IoT hub 39 receives the product selection from API 34 (which received the product selection from database management system 41) and communicates this product selection wirelessly with microcontroller 22. In the preferred embodiment, microcontroller 22 is hard-wired to control lighting system 19 in response to the signal received from IoT hub 39, but microcontroller 22 could also control lighting system 19 wirelessly. Additionally, touchscreen 43 is also controlled by software 17 if no lighting system 19 are used or it can also be used in conjunction with lights 19 to provide additional product data.

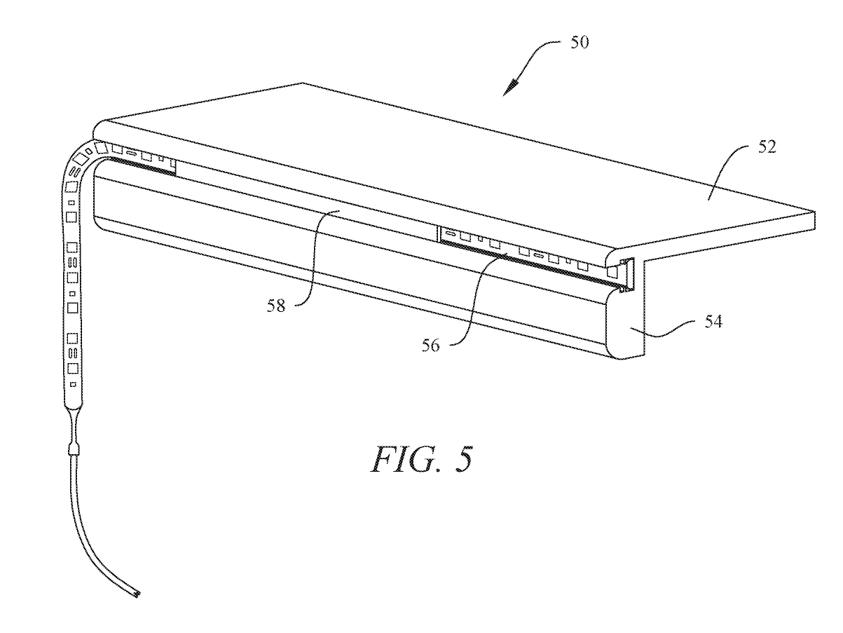

Referring to FIG. 5, shelf insert 50 for use with the present invention is shown. Shelf insert 50 is generally L-shaped with horizontal shelf component 52 and front face 54, which extends downward from and below horizontal shelf component 52. Shelf insert 50 is designed to sit on top of and hang in front of a retailer's existing shelf, and is measured and fabricated to a specific retailer's exact shelf specifications. Shelf insert 50 slides or clips in place before use. Shelf insert 50 is prefabricated to include a channel on front face 54, which houses light strip 56. Light shield 58 slides into the channel on the outside of light strip 56 to provide protection, and light shield 58 can be manufactured from glass, plastic, or a similar material and can be transparent or translucent. Additionally, shelf insert 50 is pre-wired, and has one input for power and one input for light strip wiring connections. This configuration allows for much simpler and seamless installation at a retailer's location.

Other alterations and modifications of the invention will likewise become apparent to those of ordinary skill in the art upon reading the present disclosure, and it is intended that the scope of the invention disclosed herein be limited only by the broadest interpretation of the appended claims to which the inventors are legally entitled.

1. A system for providing interactive shopping assistance to customers in a retail environment using voice comprising:
a voice input/output device that receives voice input from customers and outputs information to customers;
software that interprets the input from customers, performs a product search based on the interpreted input and returns one or more products that correspond to the interpreted input; and
a connected lighting display system to highlight the one or more returned products.

2. The system for providing interactive shopping assistance to customers of claim 1 wherein the software further comprises an administrative server containing a retailer's specific product details and rules for data manipulation.

3. The system for providing interactive shopping assistance to customers of claim 1 wherein the software further comprises artificial intelligence capabilities that learn from and use prior customer interactions with the system to return one or more products that more directly correspond to the interpreted input.

4. The system for providing interactive shopping assistance to customers of claim 1 wherein the voice input/output device comprises a speaker and a microphone.

5. The system for providing interactive shopping assistance to customers of claim 1 wherein the system further comprises a visual display screen.

6. The system for providing interactive shopping assistance to customers of claim 1 further comprising an IoT hub that receives physical location characteristics of the one or more returned products and communicates these characteristics to a microcontroller that controls the connected lighting display system.

7. A system for providing interactive shopping assistance to customers in a retail environment comprising:
voice input/output device that receives voice input from customers and outputs spoken information to customers;
software comprising a conversational bot with a speech API for converting the voice input to text and a natural language processing engine for analyzing the text, a product data retrieval API that communicates between the conversational bot and a product database, and
a connected lighting display system;
wherein the product data retrieval API performs a product search based on the voice input and retrieves one or more products from the product database that correspond to the voice input and communicates the one or more retrieved products with the conversational bot and the connected lighting display system; and
further wherein the conversational bot outputs in spoken-form the one or more retrieved products to customers.

8. The system for providing interactive shopping assistance to customers of claim 7 wherein the software further comprises an administrative server containing a retailer's specific product details and rules for data manipulation.

9. The system for providing interactive shopping assistance to customers of claim 7 wherein the software further comprises artificial intelligence capabilities that learn from and use prior customer interactions with the system to return one or more products that more directly correspond to the interpreted input.

10. The system for providing interactive shopping assistance to customers of claim 7 wherein the voice input/output device comprises a speaker and a microphone.

11. The system for providing interactive shopping assistance to customers of claim 7 wherein the voice input/output devices further comprises a visual display screen and input device.

12. The system for providing interactive shopping assistance to customers of claim 7 further comprising an IoT hub that receives physical location characteristics of the one or more retrieved products and communicates these characteristics to a microcontroller that controls the connected lighting display system.

13. A method for providing interactive shopping assistance to customers in a retail environment comprising:
receiving input from customers and outputting information to customers;
interpreting the input from customers;
performing a product search based on the interpreted input to return one or more products that correspond to the interpreted input; and
highlighting the one or more returned products.

14. The method for providing interactive shopping assistance to customers in a retail environment of claim 13 further comprising converting the input to text and analyzing the text prior to performing the product search.
